(19) United States
(12) Patent Application Publication
(10) Pub. No.: US 2012/0269059 A1
(43) Pub. Date: Oct. 25, 2012

(54) METHODS AND APPARATUS FOR CONTEMPORANEOUSLY PROVIDING QUALITY OF SERVICE FUNCTIONALITY AND LOCAL IP ACCESS

(75) Inventors: Vikram Gupta, San Diego, CA (US); Julien H. Laganier, San Diego, CA (US); John Wallace Nasielski, San Diego, CA (US)

(73) Assignee: QUALCOMM Incorporated, San Diego, CA (US)

(21) Appl. No.: 13/275,657

(22) Filed: Oct. 18, 2011

Related U.S. Application Data
(60) Provisional application No. 61/394,511, filed on Oct. 19, 2010.

(51) Int. Cl. H04W 28/02

(52) U.S. Cl. 370/229

(57) ABSTRACT

A splitter component may be used by itself or with one or more ancillary devices to provide client devices local IP access (LIPA) using local area network (LAN) addresses, while contemporaneously providing quality of service (QoS) functionality to the access terminal for data communicated via a modem, contemporaneously with providing the LIPA. The splitter device may assign a higher priority to traffic of a type having QoS functionality. The QoS functionality may include any combination of a latency requirement, a signal quality requirement, or a signal strength requirement. Providing the one or more devices LIPA using one or more LAN addresses may include assigning each of the client devices an IP address and implementing a dynamic host configuration protocol (DHCP) relay on an associated router, or other LIPA functions.

### CROSS-REFERENCE TO RELATED APPLICATION

This application claims priority pursuant to 35 U.S.C. §119(e) to U.S. provisional application Ser. No. 61/394,511, filed Oct. 19, 2010, which is hereby incorporated by reference in its entirety.

### FIELD

Aspects of the present disclosure relate generally to wireless communication systems, and more particularly, contemporaneously providing Quality of Service (QoS) functionality and Local IP access (LIPA) via an integrated device that is, or acts in coordination with, an access point of a wireless communications system.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Such multiple-access systems may use various RATs, for example, code division multiple access (CDMA), time division multiple access (TDMA), frequency division multiple access (FDMA), 3GPP Long Term Evolution (LTE), and orthogonal frequency division multiple access (OFDMA) systems.

Generally, a wireless multiple-access communication system can simultaneously support communication for multiple wireless access terminals. Each access terminal communicates with one or more base stations, also called access points, via transmissions on the downlink and uplink. The downlink refers to the communication link from the base stations to the access terminals, and the uplink refers to the communication link from the access terminals to the base stations. This communication link may be established via a single-in-single-out, multiple-in-single-out or a multiple-in-multiple-out (MIMO) system. Each base station may service one or more cells providing wireless coverage over an area determined by characteristics of an antenna group for the cell and by changing conditions of the wireless system, including but not limited to interference from neighbor base stations or other radio conditions, and time-dependent wireless resource demand within the cell.

LTE includes a set of enhancements to the Universal Mobile Telecommunications System (UMTS) mobile standard promulgated by the Third Generation Partnership Project (3GPP). LTE is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology.

In addition to mobile phone networks currently in place, a new class of small base stations, generally known as femtocells, femto access points, femto base stations, femto node or Home Node Bs (HNB), has emerged. When a femtocell is installed, it may provide access to a local network in a user's home, office, or other location. As used herein, such access may be referred to as Local Internet Protocol Access (LIPA). LIPA may be useful when a user wants to access a local area network device or service (e.g., printer, media server, etc.) from their cellular device. Generally, femtocell connectivity with the local area network (LAN) may be provided by connecting the IP interface of the femtocell to the LAN interface of a router for the LAN.

Additionally, a cellular device may also connect to the operator's macro network through the femtocell for obtaining operator-provided services provided via a backhaul connection via the femtocell to the operator's wireless network. Many such operator-provided services, for example, voice calls, may have Quality of Service (QoS) requirements that are not applicable to LIPA traffic. However, traffic for services having QoS requirements may not receive priority over other traffic emanating from the LAN. For example, voice traffic with latency requirements may not be able to obtain a desired QoS contemporaneously with a file or streaming download from the Internet to another LAN device connected to the femtocell. This problem may also be applicable to a small office, enterprise, etc., where cellular application traffic competes with LAN traffic for bandwidth and latency requirements. Handling data traffic so as to meet specific QoS requirements defined for particular portions (e.g., packets) of the traffic may be referred to herein as providing QoS functionality for data traffic, or as enabling QoS functionality for an application.

One solution to the problem of managing traffic with and without QoS requirements or with varying QoS requirements may be to directly connect the femtocell to the modem for accessing the Internet or Wide Area Network (WAN). But, generally, modem configurations may allow for only one device to receive a public IP address. Thus, with the femtocell connected directly to the modem, the router for the LAN will need to connect to the femtocell for WAN access instead of connecting directly to the WAN modem. Such a configuration may preclude the possibility of obtaining LIPA through the femtocell, because the router may be configured with a firewall and may determine the femtocell to be outside the LAN. Similar limitations may also apply to other network-enabled devices, for example, set-top boxes or gaming consoles, for which it may be desired to provide LIPA while retaining the ability for the device to connect to the Internet without sending packets through a router.

Thus, improved apparatus and methods for providing QoS functionality and LIPA to a LAN are desired.

### SUMMARY

In an aspect, a femtocell or other network-enabled device may perform a method for wireless communication including providing an access terminal with local IP access (LIPA) to one or more client devices using one or more local area network (LAN) addresses, while providing quality of service (QoS) functionality to the access terminal for data communicated via a modem or to other devices connected to a QoS splitter component that is in or connected to the femtocell, contemporaneously with providing the LIPA. In an aspect, the network-enabled device contemporaneously performing the foregoing operations may sometimes be referred to herein as a QoS splitter component. A QoS splitter component may be interposed between a femtocell and modem, or may be integrated into a femtocell which connects to a modem for Wide Area Network (WAN) access. The QoS splitter component may contemporaneously service traffic having QoS requirements from or to the femtocell while providing LIPA access for any connected device, including for the femtocell or any wireless terminal connected to the femtocell. Thus, for example, a smart phone receiving voice service via the femtocell may, contemporaneously with the voice service (that is, while the voice service or other QoS service is ongoing), send IP data to or receive IP data from any LIPA-enabled client connected to the QoS splitter component. In an aspect, a router with multiple LAN ports may be connected to the QoS splitter component, and LIPA service enabled via the QoS splitter component and router. Providing the QoS functionality may include prioritizing data according to at least one of a defined latency requirement, a defined signal quality requirement, or a defined signal strength requirement.

In another aspect, the method may include the QoS splitter receiving data of a first traffic type from at least one of the one or more devices. The first traffic type may be free of any defined QoS requirement. The method may include the QoS splitter receiving data of a second traffic type from at least one of the one or more devices, wherein the second traffic type has a designated QoS requirement. The method may include distinguishing between data of the first traffic type and second traffic type. The method may include the QoS splitter component providing a higher priority to processing the data of the second traffic type. For example, the QoS splitter may delay data of the first traffic type to meet QoS requirements for data of the second traffic type.

In another aspect, the method may include dynamically assigning data to the second traffic type. For example, an access terminal or femtocell may designate data as subject to a QoS requirement in response to some time-variable parameter or parameters. In the alternative, or in addition, the method may include statically assigning data to the second traffic type. For example, an access terminal or femtocell may designate data as subject to a QoS requirement on a fixed (not time-variable) basis. In another aspect, the method may include the QoS splitter component receiving the data of the second traffic type from one or more port types.

In another aspect, the method may include using the LIPA to allow the access terminal to discover at least one client device connected to the QoS splitter component via a LAN. Providing the LIPA may include various functions conventionally associated with LIPA. For example, providing the LIPA may include assigning LAN-connected devices an IPv4 address and implementing a dynamic host configuration protocol (DHCP) relay on an associated router. For further example, providing the LIPA may include assigning an IP address within a local area network (LAN) subnet range to connect to the LAN, performing a proxy address resolution protocol (ARP) function for each the LAN-connected devices, obtaining an IPv4 address and performing network address translation (NAT) between the IPv4 address and each of the each the LAN-connected devices, implementing a neighbor discovery proxy function to allow each of the LAN-connected devices to obtain an IPv6 address, or any useful combination of the foregoing actions.

In related aspects, a wireless communications apparatus (e.g., a QoS splitter component) may be provided for performing any of the methods and aspects of the methods summarized above. An apparatus may include, for example, a processor coupled to a memory, wherein the memory holds instructions for execution by the processor to cause the apparatus to perform operations as described above. Certain aspects of such apparatus (e.g., hardware aspects) may be exemplified by equipment such as base stations of various types used for wireless communications. Similarly, an article of manufacture may be provided, including a non-transitory computer-readable medium holding encoded instructions, which when executed by a processor, cause a wireless communications apparatus to perform the methods and aspects of the methods as summarized above.

### BRIEF DESCRIPTION OF THE DRAWINGS

The features, nature, and advantages of the present disclosure will become more apparent from the detailed description set forth below when taken in conjunction with the drawings described below. Throughout the drawings and detailed description, like reference characters may be used to identify like elements appearing in one or more of the drawings.

FIG. 1 is a schematic diagram illustrating a wireless communications system including an access point and access terminals for providing wireless service using QoS functionality.

FIG. 2 is a block diagram illustrating various details in an example of a transmitter-receiver system for wireless communications. The illustrated transmitter-receiver system may include, or may be in communication with, a QoS splitter component.

FIG. 3 is a block diagram illustrating details of a cellular communication network including femtocell and macrocells, which may provide wireless service using QoS functionality to multiple access terminals.

FIG. 4A is a block diagram illustrating a communication network including a QoS splitter component.

FIG. 4B is a block diagram illustrating functional aspects of a system for contemporaneously providing QoS functionality and LIPA to an access terminal.

FIG. 5 is a block diagram illustrating a communication network including a QoS splitter component coupled to a femtocell and to a LAN router via LAN and WAN ports.

FIG. 6 is a block diagram illustrating a communication network including a QoS splitter component coupled to a femtocell and to a LAN router via a LIPA port coupled to a WAN port.

FIG. 7 is a block diagram illustrating a communication network including a QoS splitter component incorporated into a femtocell, and coupled to a LAN router via LAN and WAN ports.

FIG. 8 is a block diagram illustrating a communication network including a QoS splitter component incorporated into a femtocell, and coupled to a LAN router via a LIPA port coupled to a WAN port, with the router coupled to a modem via a WAN port and switch.

FIG. 9 is a block diagram illustrating components of a QoS and LIPA system.

FIGS. 10-13 are flow diagrams illustrating methodologies for contemporaneously providing QoS functionality and LIPA to an access terminal, and related aspects.

FIG. 14 is a block diagram illustrating an embodiment of an apparatus for contemporaneously providing QoS functionality and LIPA to an access terminal, in accordance with the methodologies of FIGS. 10-13.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details.

The techniques described herein may be used for various wireless communication networks such as CDMA, TDMA, FDMA, OFDMA, SC-FDMA and other networks. The terms “network” and “system” may be used interchangeably herein. A CDMA network may implement a radio technology such as, for example, Universal Terrestrial Radio Access (UTRA) or CDMA 2000. UTRA includes Wideband CDMA (WCDMA) and other variants of CDMA. CDMA 2000 may be described by IS-2000, IS-95 and IS-856 standards. A TDMA network may implement a radio technology such as, for example, Global System for Mobile Communications (GSM). An OFDMA network may implement a radio technology such as, for example, Evolved UTRA (E-UTRA), Ultra Mobile Broadband (UMB), Institute of Electrical and Electronics Engineers (IEEE) standard 802.11 (Wi-Fi), IEEE 802.16 (WiMAX), IEEE 802.20, and Flash-OFDMA. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA 2000 and UMB are described in documents from an organization named “3rd Generation Partnership Project 2” (3GPP2). The techniques described herein may be used for the wireless networks and radio technologies mentioned above as well as other wireless networks and radio technologies. By way of example only, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

Aspects of the present disclosure may be adapted for use in a network that includes macro scale coverage (e.g., a large area cellular network such as a 3G networks, typically referred to as a macro cell network) and smaller scale coverage (e.g., a residence-based or building-based network environment). As an access terminal (“AT”) moves through such a network, the access terminal may be served in certain locations by access nodes (“ANs”) that provide macro coverage while the access terminal may be served at other locations by access nodes that provide smaller scale coverage. In some aspects, the smaller coverage nodes may be used to provide incremental capacity growth, in-building coverage, and different services (e.g., for a more robust user experience). In the discussion herein, a node that provides coverage over a relatively large area may be referred to as a macro node. A node that provides coverage over a relatively small area (e.g., a residence) may be referred to as a femto node. A node that provides coverage over an area that is smaller than a macro area and larger than a femto area may be referred to as a pico node (e.g., providing coverage within a commercial building).

A cell associated with a macro node, a femto node, or a pico node may be referred to as a macrocell, a femtocell, or a picocell, respectively. In some implementations, each cell may be further associated with (e.g., divided into) one or more sectors. In 3GPP, the term “cell” can refer to a coverage area of an eNB and/or an eNB subsystem serving this coverage area, depending on the context in which the term is used. Other terminology may be used to reference a macro node, a femto node, or a pico node. For example, a macro node may be configured or referred to as an access node, base station, access point, eNodeB, macrocell, and so on. Also, a femto node may be configured or referred to as a Home NodeB, Home eNodeB, access point base station, femtocell, femto access point, and so on.

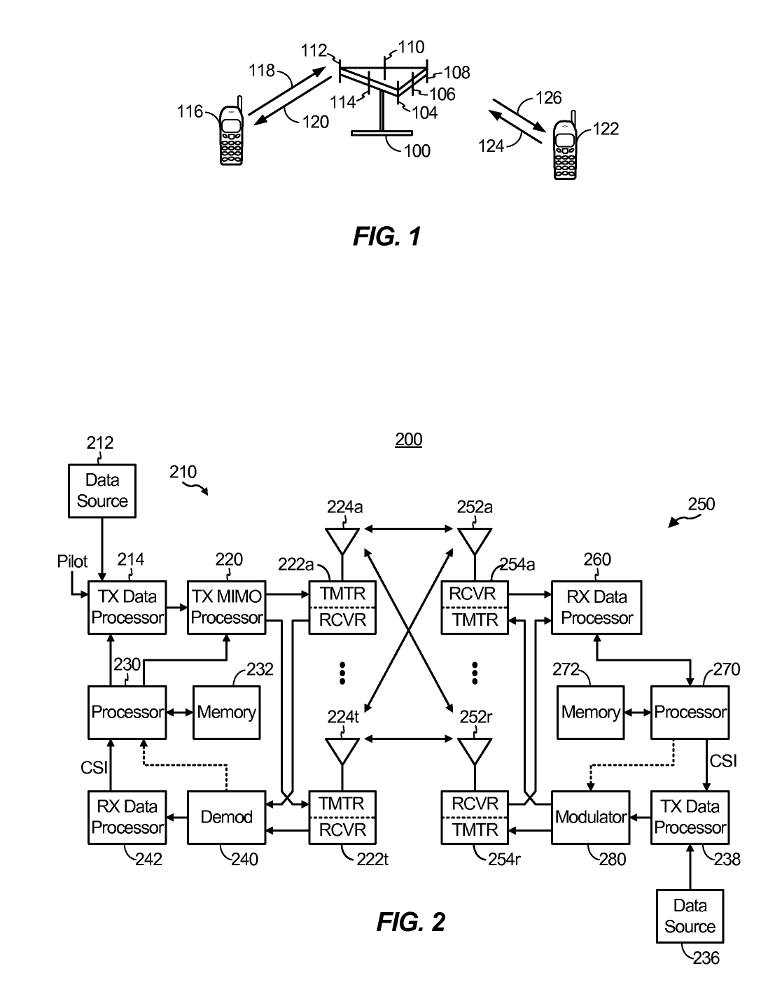

Referring to FIG. 1, a multiple access wireless communication system according to one embodiment is illustrated. An access point 100 (AP) may include multiple antenna groups, for example one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over downlink 120 and receive information from access terminal 116 over uplink 118. Access terminal 122 is in communication with antennas 106 and 108, where antennas 106 and 108 transmit information to access terminal 122 over downlink 126 and receive information from access terminal 122 over uplink 124. In a Frequency Division Duplex (FDD) system, communication links 118, 120, 124 and 126 may use different frequencies for communication. For example, downlink 120 may use a different frequency then that used by uplink 118.

Each group of antennas and/or the area in which they are designed to communicate is often referred to as a sector of the access point. In the illustrated system, antenna groups each are designed to communicate to access terminals in a sector, of the areas covered by access point 100.

In communication over downlinks 120 and 126, the transmitting antennas of access point 100 may utilize beam forming in order to improve the signal-to-noise ratio of downlinks for the different access terminals 116 and 124. An access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as an access point, a Node B, an evolved Node B (eNB), macro cell, macro cell base station or some other terminology. An access terminal may also be called an access terminal, user equipment (UE), a wireless communication device, terminal, access terminal or some other terminology.

FIG. 2 is a block diagram showing aspects of a transmitter system 210 and a receiver system 250 in a Multiple-Input Multiple-Output (MIMO) system 200. Aspects of the transmitter system may be adapted for an access point, for example a femtocell, for performing a method for contemporaneously providing LIPA and QoS functionality using a QoS splitter component as described herein. It should be appreciated, however, that a QoS splitter component and related functionality as described herein is not limited for use with femtocell applications or elements of a MIMO system 200, which are illustrated by way of example of one possible application, and not by way of limitation. Aspects of the receiver system may be adapted for an access terminal, for example a mobile station or user equipment, in communication with the access terminal. The transmitter system 210 and receiver systems 250 exemplify a suitable transmitter-receiver system in which other, more detailed aspects of the present disclosure may be practiced. It should be apparent that these more detailed aspects may also be practiced using other transmitters, receivers, or transmitter-receiver systems, and is not limited to the particular architecture illustrated in FIG. 2. It should be further apparent that a transmitter system that incorporates inventive aspects of the present disclosure will generally include other components or aspects as described elsewhere herein.

At the transmitter system 210, traffic data for a number of data streams is provided from a data source 212 to a transmit (TX) data processor 214. In some transmitter systems, each data stream may be transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams may then be provided to a TX MIMO processor 220, which may further process the modulation symbols (e.g., for OFDM). TX MIMO processor 220 then provides NT modulation symbol streams to NT transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 222a through 222t are then transmitted from NT antennas 224a through 224t, respectively.

At receiver system 250, the transmitted modulated signals may be received by NR antennas 252a through 252r. The received signal from each antenna 252 may be provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 may then receive and process the NR received symbol streams from NR receivers 254 based on a particular receiver processing technique to provide NT “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 may process received data and generate appropriate response signals according to a control methodology, using data and instructions in the operatively coupled memory 272. The methodology may include contemporaneously accessing LIPA and QoS functionality by communicating with a QoS splitter component, as described in more detail elsewhere herein.

The reverse link message may comprise various types of information regarding the communication link and/or the received data stream. The reverse link message may then be processed by a TX data processor 238, which may also receive traffic data for a number of data streams from a data source 236 to provide uplink signals. The uplink signals may be modulated by a modulator 280, conditioned by transmitters 254a through 254r, and transmitted back to transmitter system 210.

At transmitter system 210, the modulated uplink signals from receiver system 250 may be received by antennas 224, conditioned by receivers 222, demodulated by a demodulator 240, and processed by a RX data processor 242 to extract a reverse link message transmitted by the receiver system 250. Processor 230 may then determine which pre-coding matrix to use for determining the beamforming weights then processes the extracted message, using data and instructions stored in a memory 232 operable associated with the processor 230. The processor 230 may also generate messages for transmitting to the receiver system 250, to a macro base station, or to other femto base stations, and initiate other actions for contemporaneously providing LIPA and QoS functionality using a QoS splitter component, as described in more detail elsewhere herein. Instructions and data for performing these operations may be stored in the memory 232, and loaded into the processor 230 for execution at appropriate times.

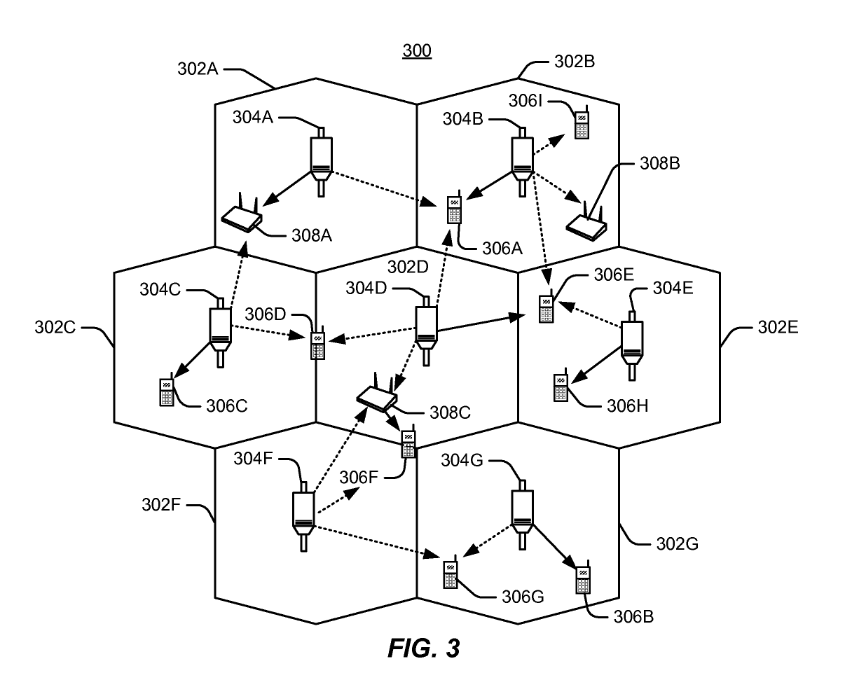

FIG. 3 illustrates a wireless communication system 300, configured to support a number of users, in which aspects of the teachings herein may be implemented. It should be appreciated, however, that QoS splitter components and related functionality may be implemented outside of system 300, in any network environment where it is desired to provide QoS functionality contemporaneously with LIPA for connected network client devices. The system 300 provides communication for multiple cells 302, such as, for example, macro cells 302A-302G, with each cell being serviced by a corresponding access point 304 (e.g., access points 304A-304G). Although non-overlapping cells are illustrated, it should be appreciated that one or more of the cells 304A-304G may overlap in whole or in part another of these cells. One or more network controllers (not shown) may couple to a set of base stations (e.g., group 304A-304G or a subset thereof) and provide coordination and control for these access points. Each network controller may communicate with the access points to which it is connected via a backhaul. The access points in group 304A-304G may also communicate with one another, e.g., directly or indirectly via wireless or wireline backhaul. Each access point in the group 304A-304G may be connected to other access points in the group via a first broadband backhaul network (not shown). The access points in group 304A-304G may be operated by one or more operators, or may be shared by different operators. The access points in group 304A-304G may use the same RAT, or may use different RATs from one another, to communicate with the access terminals. In some implementations, an access point 304 may support multiple RATs.

The system may include additional, lower power access points 308A-308C, for example, femto base stations. Accordingly, the system 300 may be considered a heterogeneous network that includes access points of different types, e.g., macro eNBs, pico eNBs, femto eNBs, relays, etc. These different types of access points may have different transmit power levels, different coverage areas, and different impact on interference in the wireless network 100. For example, macro eNBs may have a high transmit power level (e.g., 5 to 40 Watts) whereas picocell base stations, femtocell base stations and relays may have a lower transmit power level (e.g., 0.1 to 2 Watt). In addition, the different types of access points may use different RATs to communicate with the access terminals 306A-306I.

The access terminals 306A-306I may be dispersed throughout the wireless network system 300, and each access terminal may be stationary or mobile. An access terminal may also be referred to as a UE, a terminal, a mobile station, a mobile entity, a subscriber unit, a station, or other terminology. A UE may be a cellular phone, a personal digital assistant (PDA), a wireless modem, a wireless communication device, a handheld device, a laptop computer, a cordless phone, a wireless local loop (WLL) station, or other mobile entities. A UE may be able to communicate with macro eNBs, pico eNBs, femto eNBs, relays, or other network entities. In FIG. 3, a solid arrow line indicates desired transmissions between an access terminal and a serving base station, which is base station designated to serve the access terminal on the downlink and/or uplink. A dashed arrow line indicates interfering transmissions between a base station and a terminal.

As shown in FIG. 3, access terminals 306 (e.g., access terminals 306A-306I) may be dispersed at various locations throughout the system, which locations may change over time. Each access terminal 306 may communicate with one or more access points 304 on a downlink and/or an uplink at a given moment, depending upon whether the access terminal 306 is active and whether it is in soft handoff, for example. Different protocols may be used on the uplink and downlink. For example, LTE utilizes orthogonal frequency division multiplexing (OFDM) on the downlink and single-carrier frequency division multiplexing (SC-FDM) on the uplink. The wireless communication system 300 may provide wireless service over a large geographic region. For example, access points 302A-302G may be configured as macro cells covering a few blocks in a neighborhood, or larger areas. Lower-power access points such as access points 308A-308C may provide wireless service over a relatively small area, for example a portion of an office building, airport, office complex, or other service area that may be contained in one or more of the cells 302A-302G.

### Solutions for Contemporaneous QoS and LIPA Services

Low-power access points 308A-C, for example, femtocells or picocells, may be more likely to be placed in environments where the presence of a Local Area Network (LAN) sharing a modem connection to a Wide Area Network (WAN) with the access point creates a need for providing both QoS functionality and LIPA to an access point. Such needs may arise for other network devices that may be in some ways analogous to access points, for example set-top components or gaming devices that may offer QoS functionality. Generally, contemporaneously providing QoS functionality and LIPA via a hardware interface (e.g., a QoS splitter component) may be used to provide LAN connectivity to devices that are not directly connected to a router, or that are connected to the QoS splitter component via a router. Without the QoS splitter component, devices may not be able to receive IP multicast packets from the router without a dedicated interface for LIPA, because a router is not conventionally designed to forward IP multicast packets over a WAN interface. An IP multicast packet may be used in discovery of IP based services and may be received only through the dedicated LIPA interface.

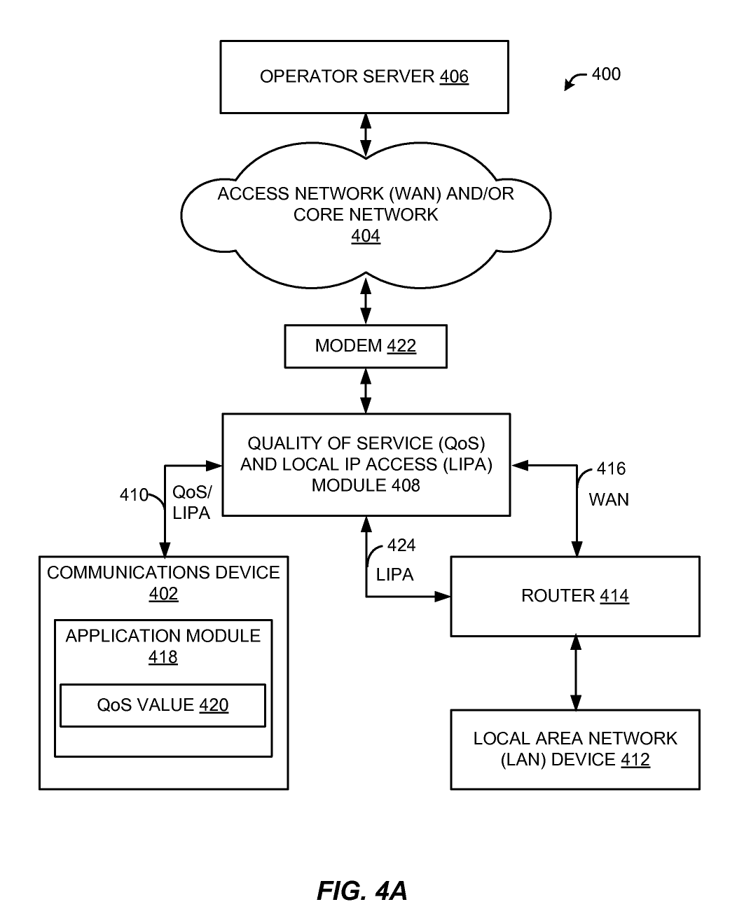

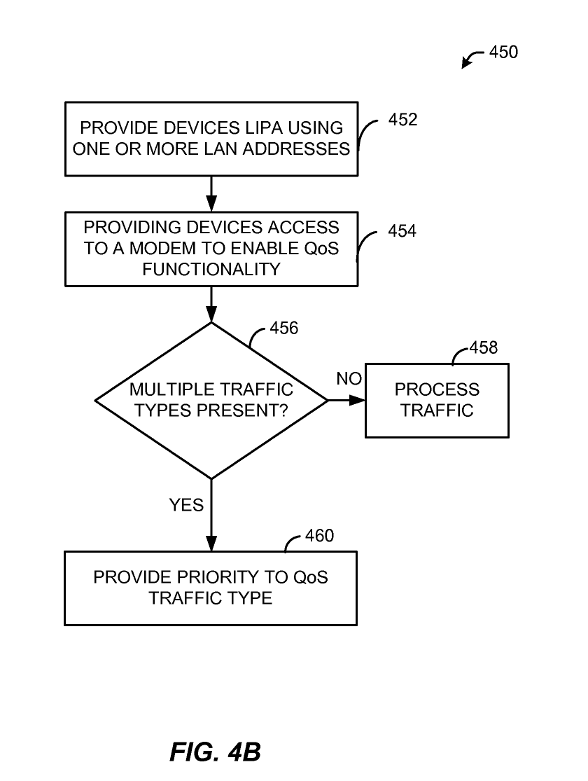

With reference to FIG. 4, a block diagram of a communication network 400 according to an aspect of the present disclosure is illustrated. Communication network 400 may include communications device 402 connected to an access network and/or core network 404, e.g., a CDMA network, a GPRS network, a UMTS network, and other types of wireline and wireless communication networks. Communication network 400 may further include one or more servers, such as an operator server 406, connected to network 404. In one aspect, operator server 406 may provide cellular-based services to a communications device 402; for example, to a wireless access terminal. Additionally, communication network 400 may include a QoS and LIPA module 408 that may be connected to one or more communications devices 402 via a QoS and LIPA connection 410. The QoS and LIPA connection 410 may service both QoS data destined for or received from a telecommunications core network or other network entity, and non-QoS data addressed to a LAN device 412 connected to the QoS and LIPA module 408 via the router 414. The QoS and LIPA module 408 may also be connected to one or more LAN devices 412 through a router 414 to provide LIPA-based services 424 and, optionally via a second connection, the WAN services 416.

The LIPA services 424 and WAN access 416 may be provided through separate physical ports or through a single port, as explained in more detail in connection with the figures below. The LIPA services 424 may permit a connection between any device having a LAN address within a subnet defined for the LAN and connected to the router 414, thereby avoiding firewall restrictions and enabling multicasting among the LAN devices. The QoS and LIPA module 408 may act as proxy device for the communications device 402 and perform LAN operations on the device's 402 behalf, such as responding to Address Resolution Protocol (ARP) messages from the router 414. WAN services 416 enable LAN devices such as device 412 to access a WAN (e.g., the Internet) via the modem 422, optionally subject to a firewall implemented by the router 414. The QoS and LIPA module 408 and router 414 may distinguish between LIPA and WAN data using IP addresses associated with respective packet data.

Communications device 402 may include an application module 418. In one aspect, application module 418 may be enabled to communication with operator server 406 and may use a QoS value 420 to ensure a sufficient quality connection is present for operations. In another aspect, application module 418 may be operable to communicate with one or more LAN devices 412 using LIPA.

QoS and LIPA module 408, also referred to herein as a QoS splitter component, may provide an interface for QoS for devices 402 to allow application module 418 to connect directly to the internet 404, and a dedicated interface that provides LIPA. Contemporaneous QoS and LIPA may be achieved through various aspects. In operation, the QoS and LIPA module 408 may be used to connect various devices 402, such as a femtocell, set-top-box, gaming consoles, etc., to a modem 422 providing Wide Area Network (WAN) (e.g., Internet) access to the WAN 404 and to the router 414 for LIPA. Further, the router 414 may be connected to the QoS and LIPA module 408 for Internet access 404. In another aspect, the QoS and LIPA module 408 may be built in to another unit, such as, for example, a femtocell, set-top box, the modem 422, or some other network-capable device.

With reference now to the block diagram of FIG. 4B, a system 450 for facilitating contemporaneously providing QoS functionality and LIPA through a hardware interface (e.g., QoS splitter component) is illustrated. At reference numeral 452, LIPA may be provided to one or more client devices using LAN addressing, using the hardware interface. Aspects of providing LIPA may include In an aspect, an addressing agent implemented in the QoS splitter component may enable each connected client device to obtain an Internet Protocol version 4 (IPv4) address valid in the LAN by implementing a DHCP relay or proxy function. A DHCP relay function may relay messages to or from the client devices up to a DHCP server component in a LAN router, through an LIPA interface. Accordingly, a DHCP proxy function may be triggered by DHCP transactions from client devices to initiate, on behalf of the client devices, a DHCP transaction to acquire, renew, or maintain a DHCP lease of an IPv4 address. In one aspect, the DHCP proxy may use 48-bit per-device Extended Unique Identifier addresses (IEEE EUI-48 addresses). Additionally or in the alternative, the addressing agent may autonomously assign to each LIPA device a different IP address from the LAN if the DHCP server is configured not to allocate addresses from an address range of the LAN subnet (e.g., LAN addressing partitioning). For example, IP address 192.168.1.1-100 may be allocated by the router, while addresses 192.168.1.101-254 may be allocated by the addressing agent. In another aspect, the addressing agent may perform a proxy address resolution protocol (ARP) function on the LAN subnet on behalf of the LIPA addresses assigned to devices. Further additionally, or in the alternative, the addressing agent may obtain a single IPv4 address for the LIPA interface and may perform network address translation (NAT) between the LIPA addresses and the devices and the address of the LIPA interface. In such an aspect, no proxy ARP function may be necessary and all devices may be able to use a single LAN IP address for LIPA.

In still another aspect of providing LIPA 452, the addressing agent implemented in a QoS splitter component may allow each device to obtain an Internet Protocol version 6 (IPv6) 128-bit address valid in the LAN by implementing a Neighbor Discovery Proxy (RFC 4389) function, for example as described in the Internet Engineer Task Force (IETF) Request For Comments (RFC) 4389. The Neighbor Discovery Proxy function as described in RFC 4389 may proxy (act as an intermediary) for Neighbor Discovery messages and forward data packets without decrementing a time to live (TTL) between the LIPA devices and the LAN. Accordingly, all LIPA devices may appear to be attached to the LAN.

At reference numeral 454, a QoS splitter component may provide the one or more client devices with direct access to a modem to enable applications with QoS requirements to function properly. The modem may provide access to a WAN, and may be connected to via a WAN port. In an aspect, QoS requirements may include, latency requirements, signal quality requirements, signal strength requirements, or other requirements for maintaining a specified QoS. The one or more client devices may include an access terminal, mobile entity or UE as used in mobile wireless communications systems.

At reference numeral 456, a QoS splitter component may determine whether multiple traffic types are present in traffic that the splitter component is handling for one or more clients. For example, the QoS splitter component may determine whether multiple devices are attempting to communicate using different traffic types. If at reference numeral 456, it is determined that multiple traffic types are not present, then at reference numeral 458, the QoS component may process data of any present traffic, for example by handling the traffic to as to provide access to the WAN with QoS functionality via the modem, or LIPA via a connected LAN router.

In the alternative, if at reference numeral 456, the QoS splitter component determines that multiple traffic types are present in traffic that the splitter component is handling for one or more clients, then at reference numeral 460, the QoS splitter component may assign priority to processing traffic types associated with QoS requirements. Processing may include handling the traffic to as to provide access to the WAN with QoS functionality via the modem, or LIPA via a connected LAN router. In an aspect, macro network traffic to/from various devices may have conflicting requirements. In such an aspect, priority may be provided to different traffic. For example, traffic from cellular devices may be provided higher priority than traffic from LAN devices. Further, different priority may be provided to different traffic streams based on the traffic type. For example, voice over IP (VOIP) traffic from a LAN device or cellular voice traffic from the femtocell may be provided higher priority than file transfer traffic from a connected device. Such prioritizing of flows may enable QoS for real time applications, using the QoS splitter component.

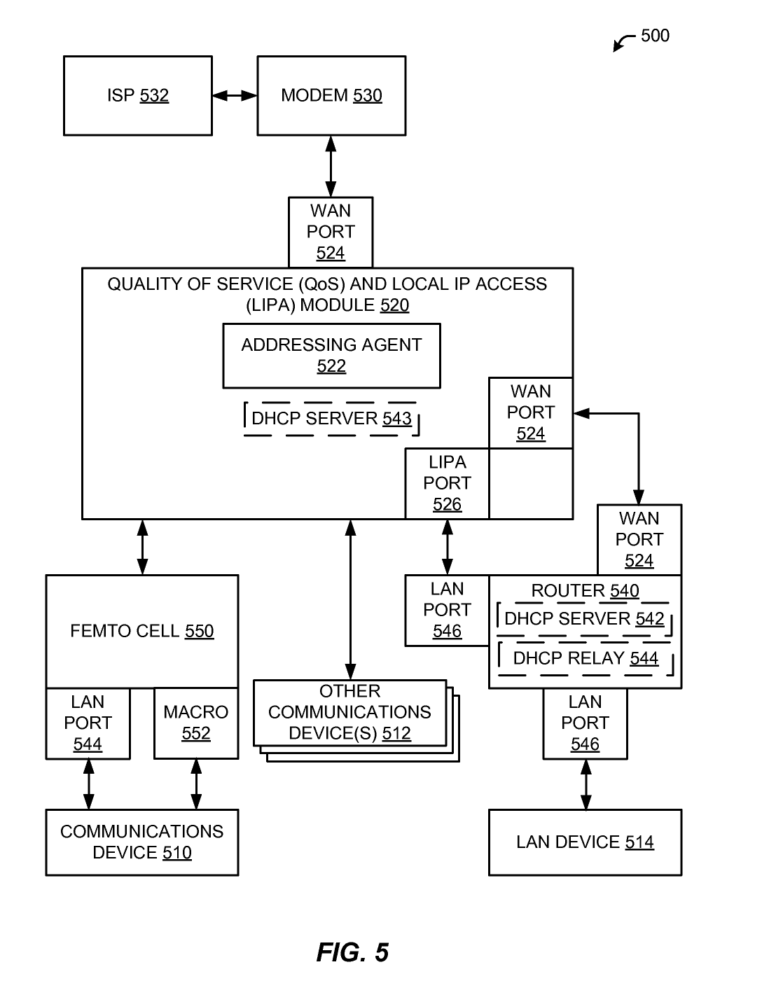

Referring to FIG. 5, an example of a communication network 500 including a QoS splitter component 520 is illustrated. The example network 500 may include one or more communications device 510, for example a wireless access terminal of various types, a smart phone, mobile phone, notebook or notepad computer, smart media device, or other client device. The network 500 may further include one or more other networking devices 512, for example a set-top box or gaming device. The network 500 may include a QoS and LIPA module 520 connected to a WAN via a modem 550 and to a router 540 servicing one or more LAN devices 514 via corresponding LA ports 546. The network 500 may further include a wireless access point, for example a femtocell 550, interposed between the QoS splitter component 520 and the one or more client devices 510.

In an aspect, a communications device 510 may be operably coupled through femtocell 550 to other devices (512, 514) in the network 500 using a LAN port 544 of the femtocell 550. The femtocell 550 may provide IP connectivity via the LAN port 544 and upstream QoS splitter component 520. The femtocell 550 may connect the client device 510 to an internet service provider (ISP) 552 using a macro wireless connection 552.

The QoS splitter component 520, also called the QoS and LIPA module, may be operable to contemporaneously provide QoS functionality and LIPA to one or more client devices, such as the devices 510, 512, or 514. In an aspect, QoS and LIPA module 520 may include an addressing agent component 522, one or more wide area network (WAN) ports 524 and one or more LIPA ports 526. Additionally, the QoS and LIPA module 520 may also include a DHCP server 543, which may be enabled or disabled depending on a desired operating configuration.

In operation, LIPA may be provided to one or more devices 510, 512 using LAN addressing. The addressing agent 522 may allow each device 510, 512 to obtain an IPv4 address valid in the LAN by implementing a DHCP relay or proxy function. Further, the DHCP relay 544 may relay the messages to/from the devices up to a DHCP server 542 in a router 540 through an LAN port 546 to an LIPA port 526. In such an aspect, the DHCP relay 544 may be triggered by DHCP transactions from client devices 510, 512 to initiate, on their behalf, a DHCP transaction to acquire, renew, or maintain a DHCP lease of an IPv4 address. In an aspect, the DHCP relay 544 may use per-device IEEE EUI-48 addresses. Additionally or in the alternative, the addressing agent 522 may autonomously assign to each LIPA device 510, 512 a different IP address from the LAN if the DHCP server 542 is configured not to allocate addresses from an address range of the LAN subnet (e.g., LAN addressing partitioning). For example, IP address 192.168.1.1-100 may be allocated by the router 540, while addresses 192.168.1.101-254 may be allocated by the addressing agent 522. In another aspect, the addressing agent 522 may perform a proxy address resolution protocol (ARP) function on the LAN subnet on behalf of the LIPA addresses assigned to client devices 510, 512. Further additionally, or in the alternative, the addressing agent 522 may obtain a single IPv4 address for the LIPA port 526 and may perform network address translation (NAT) between the LIPA addresses and the client devices 510, 512 and the address of the LIPA port 526. In such an aspect, no proxy ARP function may be necessary and all client devices 510, 512 may be able to use a single LAN IP address for LIPA. In still another aspect, the addressing agent 522 may allow each client device 510, 512 to obtain an IPv6 address valid in the LAN by implementing a Neighbor Discovery Proxy (RFC 4389) function. The Neighbor Discovery Proxy function may act as an intermediary for Neighbor Discovery messages and forward data packets without decrementing a time to live (TTL) between the LIPA client devices 510, 512 and the LAN. In such an aspect, all LIPA client devices 510, 512 may appear to be attached to the LAN.

Additionally, the DHCP server 542 at the router may be disabled, so that DHCP and NAT functionality may be hosted instead by the QoS and LIPA module 520 using the DHCP server component 543. In such case, a DHCP relay 544 function at the router 540 and the DHCP server component 543 at the QoS and LIPA module 520 may both be enabled. Conversely, in the alternative configuration, the DHCP server 542 at the router may be enabled, and the DHCP relay 544 function at the router 540 and the DHCP server component 543 at the QoS and LIPA module 520 may both be disabled.

Additionally, the QoS and LIPA module 520 may be operable to prioritize processing of different traffic types. In an aspect, macro traffic to or from various client devices 512, 514 may have conflicting requirements. In such an aspect, priority of processing by the QoS splitter component 520 may be provided to different traffic. For example, traffic from cellular devices 510 may be provided higher priority than traffic from LAN devices 514. Further, different priority may be provided to different traffic streams based on the traffic type. For example, voice over IP (VOIP) traffic from a LAN device 514 or cellular voice traffic from the femtocell 550 may be provided higher priority than file transfer traffic from a connected device 512. Such prioritizing of flows may enable QoS for real time applications. In another aspect, different ports may be static assigned to be processed at a higher priority. For example, LIPA ports 526 may be processed with a higher priority than WAN ports 524.

In operation, the QoS and LIPA module 520 may receive an IP address from the modem 530. Thereafter, the QoS and LIPA module 520 may provide an IP address to the WAN port 524 of the router 540. In an aspect, the QoS and LIPA module 520 may ensure that the IP address provided to the router 540 indicates a different subnet than the one being advertised by the DHCP server 542 in the router. The QoS and LIPA module 520 may also perform NAT for all packets sent and received on the WAN port 524.

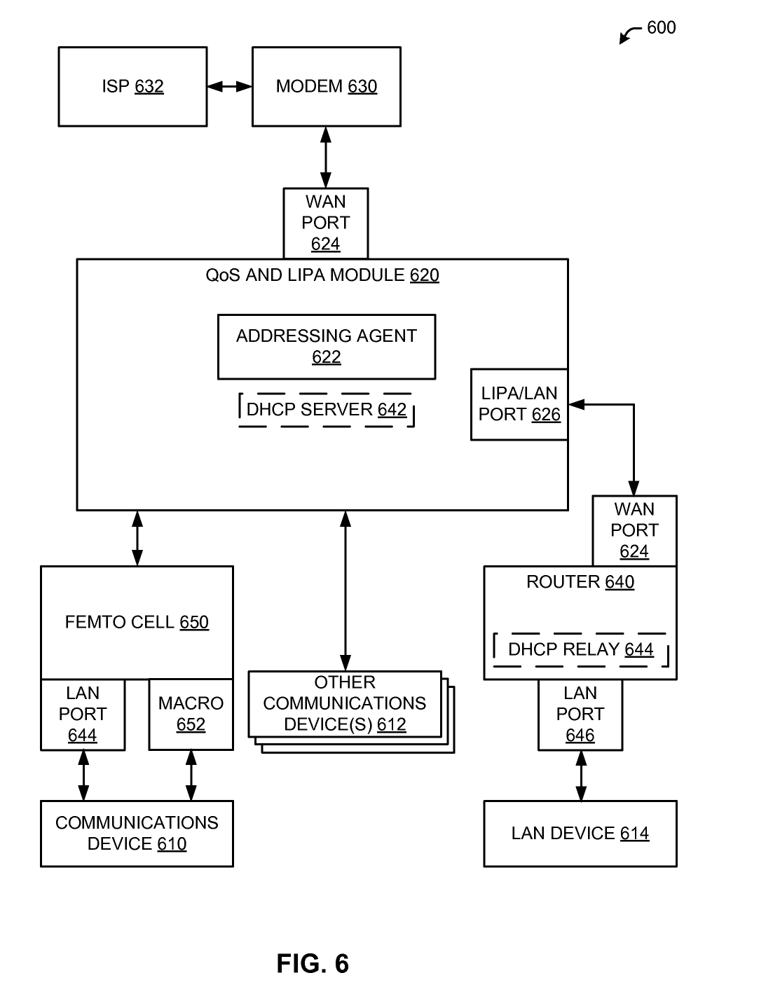

Referring to FIG. 6, an example of an alternative architecture for a communication network 600 including a QoS splitter component 620, also called a QoS and LIPA module, is illustrated. The example network 600 may include one or more communications devices 610, one or more other devices 612, a QoS and LIPA module 620, a modem 630, a router 640, one or more LAN devices 614 and a femtocell 650. The one or more communications devices 620 may be, or may include, a wireless access terminal, mobile entity, user equipment of any suitable form, for example, a smart phone, mobile phone, notebook or notepad computer, smart media device, or other client device. The other devices 612 may include any suitable network-enabled device, for example a gaming device, set-top box, or smart television. The LAN devices 614 may include any suitable client device or terminal capable of communicating over the LAN.

In one aspect, communications device 610 may be connected to the femtocell 650 using at least one of a LAN port 644 or a macro port 652. The QoS and LIPA module 620 may include an addressing agent 622, optionally a DHCP server 642, one or more WAN ports 624, and one or more LIPA/LAN ports 626. In an aspect, the modem 630 may communicate with QoS and LIPA module 620 through the WAN port 624, and may be operable to communicate with an ISP 632. The router 640 may include a DHCP relay 644 enabling communicate with the QoS splitter component 620 through one or more WAN ports 624 connected to the LIPA/LAN port 626, and via one or more LAN ports 646 to one or more corresponding LAN client devices 614. In such case, LAN devices 614 may communicate with an ISP 632 through router 640 and the QoS and LIPA module 620.

In the configuration depicted in FIG. 6, the LIPA/LAN port 626 of QoS and

LIPA module 620 may be connected to the WAN port 624 of the router 640. In such case, the router may act as a switch. Accordingly, this configuration may allow the QoS and LIPA module 620 or femtocell 650 to have one less network interface. The DHCP Server component 642 may enable the QoS and LIPA module 620 to emulate aspects of a router and enable the port 626 to operate as a LAN port, with the actual router 640 acting as a switch using the DHCP relay component 644. A single LIPA/LAN port 626 may therefore service both LIPA traffic between the femtocell 650 and LAN device 614, and WAN traffic between the modem 630 and LAN device 614. Further, in such an aspect, the router 640 may forward local IP packets received from the LIPA/LAN port 626 to the one or more LAN clients 614.

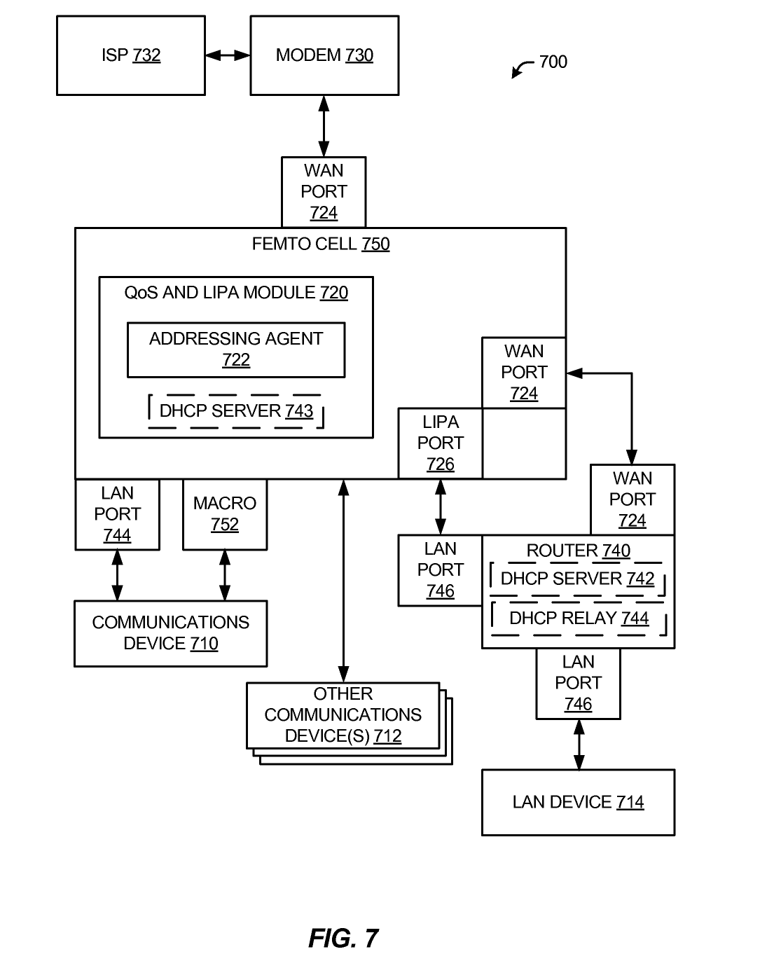

Referring to FIG. 7, an example of an alternative architecture for a communication network 700 is illustrated, including a QoS splitter component 720, also called a QoS and LIPA module, incorporated into a femtocell 750. The example network 700 may include one or more communications devices 710, one or more other devices 712, a QoS and LIPA module 720, a modem 730, a router 740, one or more

LAN devices 714 and a femtocell 750. The one or more communications devices 720 may be, or may include, a wireless access terminal, mobile entity, user equipment of any suitable form, for example, a smart phone, mobile phone, notebook or notepad computer, smart media device, or other client device. The other devices 712 may include any suitable network-enabled device, for example a gaming device, set-top box, or smart television. The LAN devices 714 may include any suitable client device or terminal capable of communicating over the LAN.

In the depicted aspect, QoS and LIPA module 720 may be integrated into femtocell 750. In one aspect, the communications device 710 may be connected to the femtocell 750 using at least one of a LAN port 744 or a macro port 752. In an aspect, the QoS and LIPA module 720 may include an addressing agent 722, and optionally a DHCP server 743, which may be enabled or disabled depending on a desired operating configuration. Further, the femtocell 750 may include the QoS and LIPA module 720, one or more WAN ports 724, and one or more LIPA ports 726. The modem 730 may be operable to communicate with femtocell 750 through a WAN port 724 and may be operable to communicate with an ISP 732. The router 740 may include a DHCP server 742 a DHCP relay 744, both of which may be enabled or disabled depending on a desired operating configuration. The router 740 may communicate through one or more WAN ports 724 and one or more LAN ports 746. In such an aspect, LAN devices 714 may communicate with an ISP 732 through router 740 and femtocell 750.

In an aspect, the DHCP server 742 at the router may be disabled, so that DHCP and NAT functionality may be hosted instead by the QoS and LIPA module 720 using the DHCP server component 743. In such case, a DHCP relay 744 function at the router 740 and the DHCP server component 743 at the QoS and LIPA module 720 may both be enabled. Conversely, in the alternative configuration, the DHCP server 742 at the router may be enabled, and the DHCP relay component 744 at the router 740 and the DHCP server component 743 at the QoS and LIPA module 720 may both be disabled.

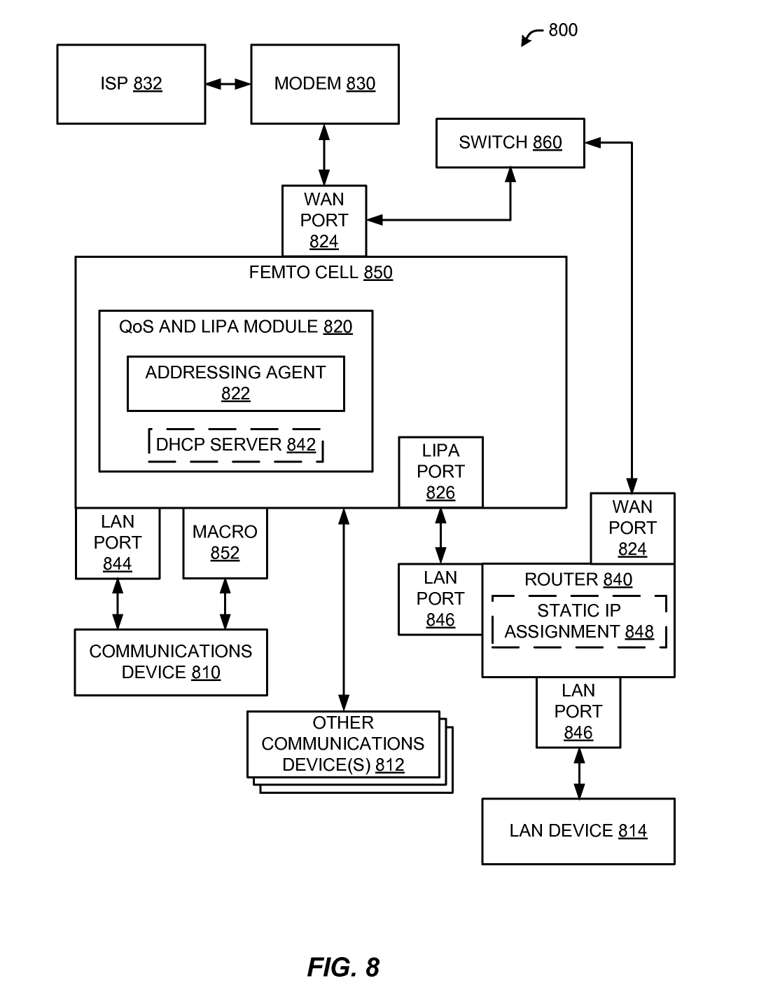

Referring to FIG. 8, an example of an alternative architecture for a communication network 800 is illustrated, including a QoS splitter component 820, also called a QoS and LIPA module, incorporated into a femtocell 850. The example network 800 may include one or more communications devices 810, one or more other devices 812, a QoS and LIPA module 820, a modem 830, a router 840, one or more LAN devices 814, a femtocell 850 and a switch 860. The one or more communications devices 820 may be, or may include, a wireless access terminal, mobile entity, user equipment of any suitable form, for example, a smart phone, mobile phone, notebook or notepad computer, smart media device, or other client device. The other devices 812 may include any suitable network-enabled device, for example a gaming device, set-top box, or smart television. The LAN devices 814 may include any suitable client device or terminal capable of communicating over the LAN.

The QoS and LIPA module 820 may be integrated into the femtocell 850. In an aspect, the one or more communications device 810 may be connected to the femtocell 850 using at least one of a LAN port 844 or a macro port 852. The QoS and LIPA module 820 may be include an addressing agent 822, and optionally a DHCP server 842. Further, the femtocell 850 may include QoS and LIPA module 820, one or more WAN ports 824, and one or more LIPA ports 826. The modem 830 may communicate with the femtocell 850 through a WAN port 824 and with an ISP 832. The router 840 may include a static IP assignment module 848 and may communicate through one or more WAN ports 824 and one or more LAN ports 846. In such an aspect, LAN devices 814 may communicate with an ISP 832 through router 840 and femtocell 850.

A switch 860 may enable contemporaneous QoS functionality and LIPA to be achieved through respective Network Interface Card (NIC) interfaces on the femtocell 850. For example, an IP address on the WAN 824 for the router 840 may be statically assigned 848 with the router DHCP client being disabled. Further, two IP interfaces may be bound on the WAN 824 of the femtocell 850, wherein a first interface may be used to send a DHCP request to the modem 830 and a second interface may be operable through switch 860 to provide a WAN gateway for the router 840. Other devices may be attached to the switch 860 as long as the IP address is assigned statically and the virtual interface on the femtocell 850 WAN port 824 is used as the gateway to the modem 830.

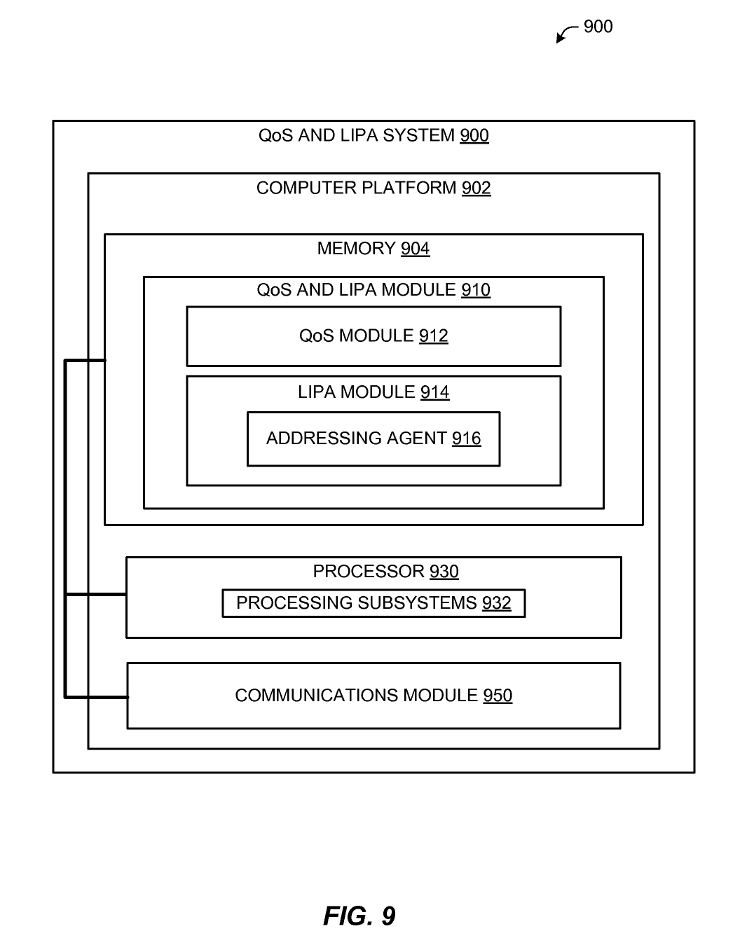

With reference to FIG. 9, a QoS and LIPA system 900 may include a QoS and LIPA module 408 depicted in FIG. 4A. The QoS and LIPA system 900 may comprise at least one of any suitable type of hardware, server, personal computer, mini computer, mainframe computer, with one or more processors programmed to perform functions and algorithms as described herein. Further, the modules and applications described herein as being operated on or executed by QoS and LIPA system 900 may be executed entirely on a single network device, as shown in FIG. 9, or alternatively, in other aspects, separate servers, databases or computer devices may work in concert to provide support for modules and applications executed by QoS and LIPA system 900.

The QoS and LIPA system 900 may include a computer platform 902 capable of transmitting and receiving data across wired and/or wireless networks, and that can execute routines and applications. The computer platform 902 may include a memory 904, which may comprise volatile and nonvolatile memory such as read-only and/or random-access memory (ROM and RAM), EPROM, EEPROM, flash cards, or any memory common to computer platforms. Further, the memory 904 may include one or more flash memory cells, or may be any secondary or tertiary storage device, such as magnetic media, optical media, tape, or soft or hard disk. The computer platform 902 may also include a processor 930, which may be an application-specific integrated circuit (“ASIC”), or other chipset, logic circuit, or other data processing device. The processor 930 may include various processing subsystems 932 embodied in hardware, firmware, software, and combinations thereof, that enable the functionality of the QoS and LIPA system 900 on a wired or wireless network. In an aspect, the processor 930 may provide means for providing one or more devices LIPA using one or more LAN addresses, and means for providing the one or more devices access to a modem contemporaneously to enable one or more applications with a QoS functionality.

The computer platform 902 may further include a communications module 950 embodied in hardware, firmware, software, and combinations thereof, that enables communications among the various components of the QoS and LIPA system 900, as well as between QoS and LIPA system 900 and client devices as described herein above. The communication module 950 may include the requisite hardware, firmware, software and/or combinations thereof for establishing a wireless communication connection. According to described aspects, communication module 950 may include the necessary hardware, firmware and/or software to facilitate wireless and/or wireline communication between network entities.

The memory 904 of the QoS and LIPA system 900 may include the QoS and LIPA module 910 operable to contemporaneously support QoS and LIPA functionality for one or more devices, as described in more detail elsewhere herein. In one aspect, QoS and LIPA module 910 may include a QoS module 912 to enable applications with QoS requirements access to a modem, and LIPA module 914.

In one aspect, LIPA module 914 may include addressing agent 916 as described in more detail elsewhere herein. For example, the addressing agent 916 may allow one or more client devices to obtain an IPv4 address valid in the LAN by implementing a DHCP relay or proxy function, or may allow each device to obtain an IPv6 address valid in the LAN by implementing a Neighbor Discovery Proxy (RFC 4389) function, and perform related or alternative functions as described in more detail above in connection with block 452 of FIG. 4B.

To achieve these and other technical effects related to providing QoS functionality and LIPA for an access terminal, including the various enhancements described above, new methodologies and apparatus as described below may be adapted for use with existing and future wireless communications protocols. The methodologies and apparatus may incorporate details of the systems and apparatus described above, and may overcome certain disadvantages and limitations of the prior art as noted in the Background above. For example, the present solutions may enable a higher priority to be assigned to traffic for services having QoS requirements than to other traffic emanating from or directed to the LAN. For further example, the present solutions may overcome the limitations of directly connecting a prior-art femtocell or analogous network device to a modem for accessing the Internet, where equipment such as routers and modems only allow for a single device to receive a public IP address. Such limitations may include precluding the possibility of obtaining LIPA through the femtocell or analogous device, because the router may be configured with a firewall. The present solutions may enable a femtocell or analogous device to provide LIPA through a router for a LAN, while retaining the ability to connect to the Internet without sending packets through a router, and at the same time supporting QoS functionality.

### Example Methodologies and Apparatus

In view of exemplary systems shown and described herein, methodologies that may be implemented in accordance with the disclosed subject matter, will be better appreciated with reference to various flow charts. For purposes of simplicity of explanation, methodologies are shown and described as a series of acts/blocks, but the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored as encoded instructions and/or data on an article of manufacture to facilitate transporting and transferring such methodologies to various devices. Those skilled in the art will understand and appreciate that a method could alternatively be represented as a series of interrelated states or events, such as in a state diagram.

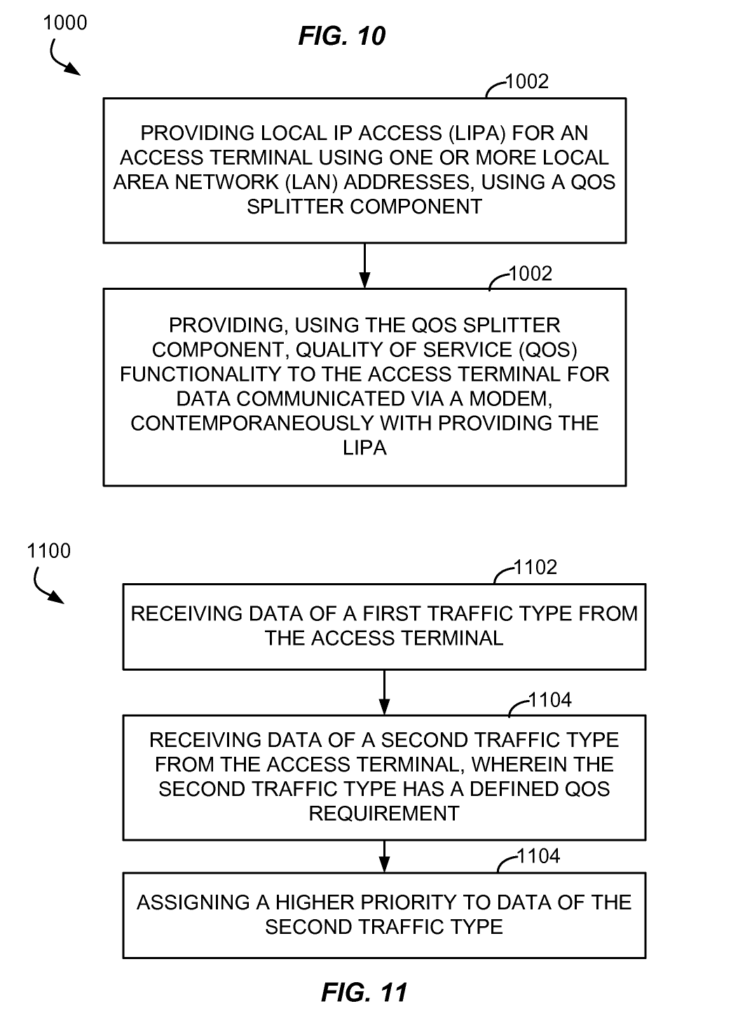

A network entity may perform a method 1000 for handling network traffic, as shown in FIG. 10. The network entity may be, or may include, QoS splitter component, which may be configured as a separate device or incorporated into another communications device, for example, into a femtocell or picocell of any of the various forms described herein. The method may include, at 1002, the QoS splitter component providing local IP access (LIPA) for an access terminal using one or more local area network (LAN) addresses. The method may further include, at 1003, the QoS splitter component providing quality of service (QoS) functionality to the access terminal for data communicated via a modem, contemporaneously with providing the LIPA. The QoS splitter component may be interposed between a femtocell and modem, or may be integrated into a femtocell which connects to a modem for Wide Area Network (WAN) access. The QoS splitter component may contemporaneously service traffic having QoS requirements from or to the femtocell while providing LIPA access for any connected device, including for the femtocell or any wireless terminal connected to the femtocell. Thus, for example, a smart phone receiving voice service via the femtocell may, contemporaneously with the voice service (that is, while the voice service or other QoS service is ongoing), send IP data to or receive IP data from any LIPA-enabled client connected to the QoS splitter component. In an aspect, a router with multiple LAN ports may be connected to the QoS splitter component, and LIPA service enabled via the QoS splitter component and router.

FIGS. 11-13 show further optional operations or aspects 1100, 1200 or 1300 that may be performed by a QoS splitter component in conjunction with the method 1000, or in some cases independently of said method. The operations shown in FIGS. 11-13 are not required to perform the method 1000. The operations are independently performed and not mutually exclusive. Therefore any one of such operations may be performed regardless of whether another downstream or independent upstream operation is performed. If the method 1000 includes at least one operation of FIGS. 11-13, then the method 1000 may terminate after the at least one operation, without necessarily having to include any subsequent downstream operation(s) that may be illustrated.

Referring to FIG. 11, method 1000 may include one or more of the additional operations 1100. In an aspect, the method 1000 may further include, at 1102, the QoS splitter component receiving data of a first traffic type from the access terminal. The method 1000 may further include, at 1104, the QoS splitter component receiving data of a second traffic type from the access terminal, wherein the second traffic type has a defined QoS requirement. The method 1000 may further include, at 1104, the QoS splitter component assigning a higher priority to data of the second traffic type. Assigning a higher priority may include determining a type of one or more data packets, for example by reading a packet header or other data bit associated with the one or more packets. Traffic type may be indicated using any suitable signaling method. In the alternative, the traffic type may be determined implicitly from a context of communications with a client device or network entity. Once the QoS splitter component has determined a traffic type for one or more data packets, the component may allocate bandwidth on available network ports so that higher-priority packets are transmitted from the QoS component earlier than lower-priority packets, of the lower-priority packets are transmitted using a medium that does not cause an undesirable or impermissible amount of delay in transmission of the high-priority packets.

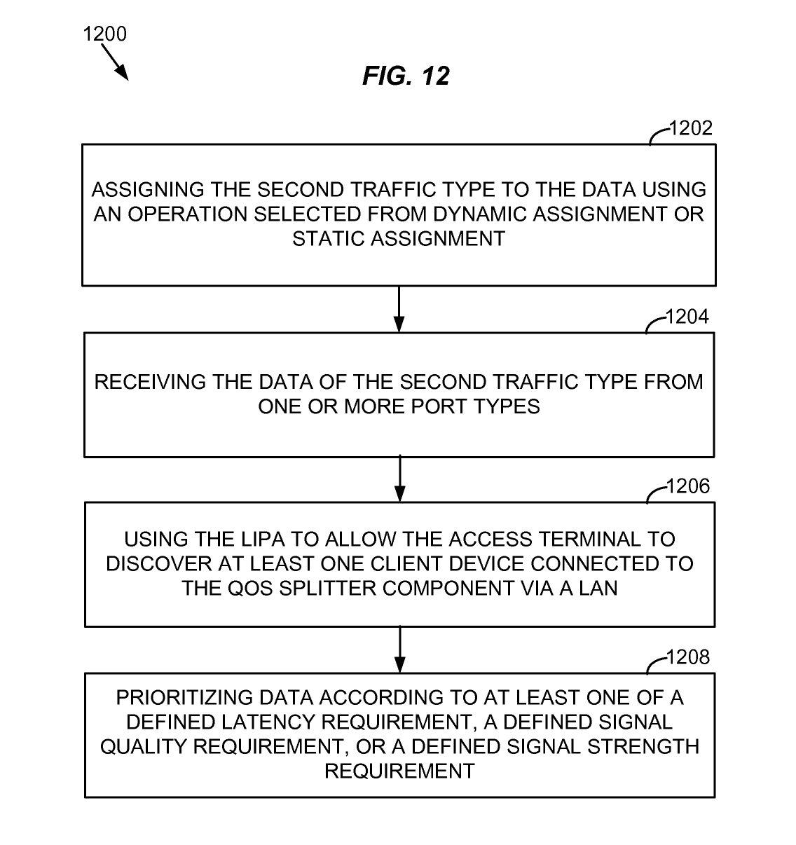

Referring to FIG. 12, method 1000 may include one or more of the additional operations 1200. In an aspect, the method 1000 may further include, at 1202, a client or network entity assigning the second traffic type to the data using an operation selected from dynamic assignment or static assignment. Accordingly, the QoS splitter component may determine a data type based on whether the data type is indicated as being a dynamic assignment, or as a static assignment. A dynamic assignment of data type may change from time to time, for data from a particular device or from a device in a defined configuration. Static assignment means that the data type does not change for a particular device or for a defined device configuration. For example, a dedicated phone client may have a static data type subject to QoS requirements.

The method 1000 may further include, at 1204, the QoS splitter component receiving the data of the second traffic type (e.g., the QoS data) from one or more port types. For example, the QoS splitter component may receive QoS data only from a macro port for wireless cellular communications. In an alternative example, the QoS splitter component may receive QoS data from both the a macro port and a LAN port.

The method 1000 may further include, at 1206, using the LIPA to allow the access terminal to discover at least one client device connected to the QoS splitter component via a LAN. For example, a mobile phone access terminal connected to the QoS component may be enabled to discover, and thereby communicate with, any device connected to via a router to the QoS splitter component. This may be useful, for example, for transferring data to or from the mobile phone device to devices such as personal computers, printers, or a wide variety of other network-enabled devices. The method 1000 may further include, at 1208, the QoS splitter component prioritizing data according to at least one of a defined latency requirement, a defined signal quality requirement, or a defined signal strength requirement. For example, latency, signal quality, and signal strength may be used as control parameters for determining how the QoS component prioritizes traffic that it processes. The QoS splitter component may allocate bandwidth to data having QoS requirements to achieve one or more of the foregoing metrics, for example using an open loop control algorithm.

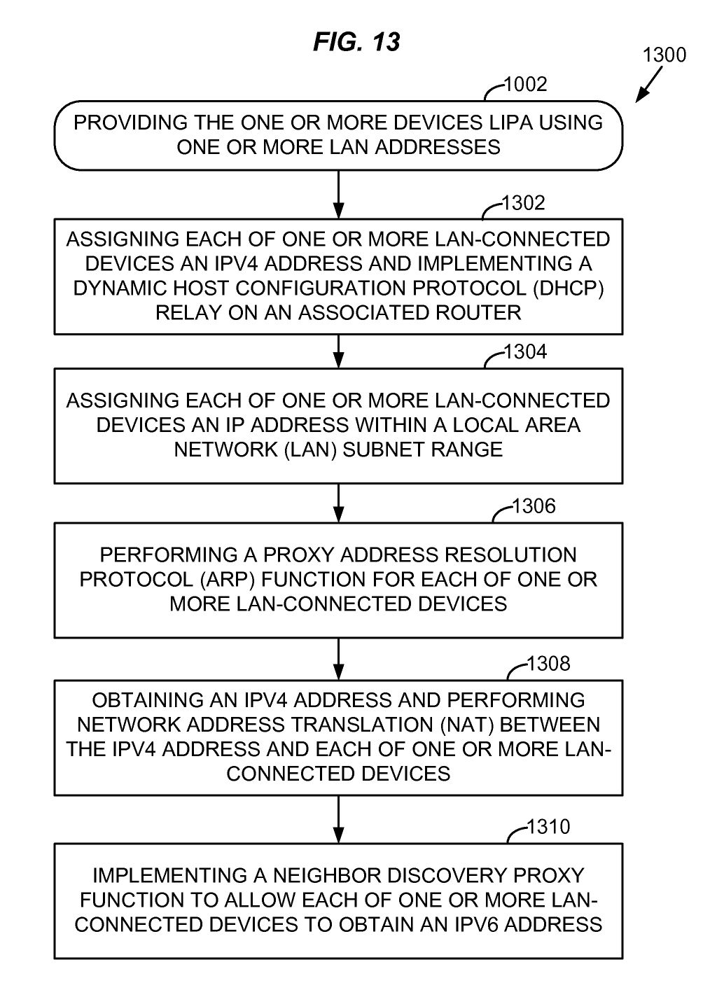

Referring to FIG. 13, method 1000 may include one or more of the additional operations 1300 for providing the one or more client devices LIP using one or more LAN addresses 1002. In an aspect, the method 1000 may further include, at 1302, the QoS splitter component assigning each of one or more LAN-connected devices an IPv4 address and implementing a dynamic host configuration protocol (DHCP) relay on an associated router. The method 1000 may further include, at 1304, the QoS splitter component assigning each of one or more LAN-connected devices an IP address within a local area network (LAN) subnet range. The method 1000 may further include, at 1306, the QoS splitter component performing a proxy address resolution protocol (ARP) function for each of one or more LAN-connected devices. The method 1000 may further include, at 1308, the QoS splitter component obtaining an IPv4 address and performing network address translation (NAT) between the IPv4 address and each of one or more LAN-connected devices. The method 1000 may further include, at 1310, the QoS splitter component implementing a neighbor discovery proxy function to allow each of one or more LAN-connected devices to obtain an IPv6 address. It should be appreciated that the QoS splitter component is not limited to foregoing examples of aspects for providing LIPA. The essential elements of these examples, which may be understood as managing assignment or use of addresses for devices connecting to a LAN that is in turn connected to the QoS splitter component, may be implemented using alternative protocols or operations.

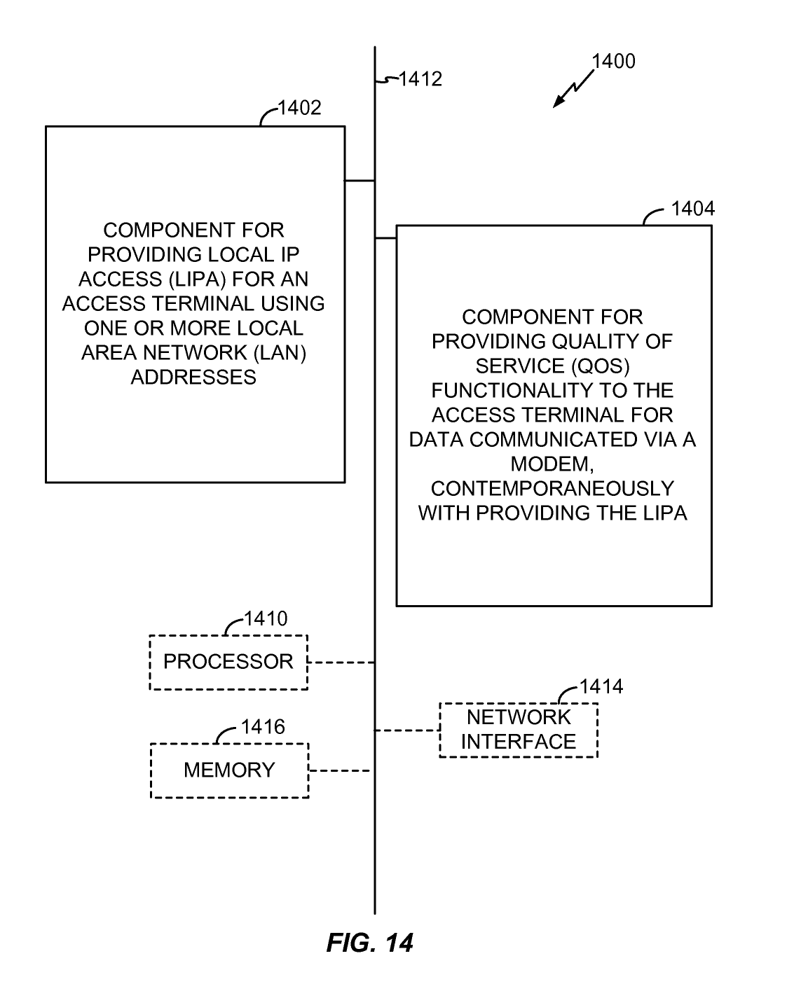

With reference to FIG. 14, there is provided an exemplary apparatus 1400 that may be configured as QoS splitter component being a separate device or incorporated into another communications device, for example, into a femtocell or picocell of any of the various forms described herein, or as a processor or similar device for use within the QoS splitter component, for controlling traffic so as to contemporaneously provide LIPA and QoS functionality. The apparatus 1400 may include functional blocks that can represent functions implemented by a processor, software, or combination thereof (e.g., firmware).

In one embodiment, the apparatus 1400 may include an electrical component or module 1402 for providing local IP access (LIPA) for an access terminal using one or more local area network (LAN) addresses. For example, the electrical component 1402 may include at least one control processor coupled to a transceiver or the like and to a memory with instructions for managing assignment of addresses for LAN devices connecting via a router to the electrical component. The electrical component 1402 may be, or may include, a means for providing LIPA for an access terminal using one or more LAN addresses. Said means may be or may include the at least one control processor operating an algorithm. The algorithm may operate in an application to perform detailed operations for managing LAN addresses, for example as described in connection with FIG. 13 above. Said means may include other aspects, such as the hardware and software components illustrated in FIGS. 5-9 for providing LIPA access.

The apparatus 1400 may include an electrical component 1404 for providing QoS functionality to the access terminal for data communicated via a modem, contemporaneously with providing the LIPA. For example, the electrical component 1404 may include at least one control processor coupled to a memory holding instructions for differentiating between traffic subject to QoS requirements and LIPA traffic, coupled to a modem port for coupling to a modem and a LIPA port for coupling to a router. The electrical component 1404 may be, or may include, a means for providing QoS functionality to the access terminal for data communicated via a modem, contemporaneously with providing the LIPA. Said means may be or may include the at least one control processor operating an algorithm. The algorithm may operate in a processor of the QoS splitter component to determine whether or nor one or more data packets subject to QoS requirements, for example by reading a packet header or other data bit associated with the one or more packets, or detecting any other useful indication of QoS requirements that can be allocated to specific data passing through the splitter component, including both explicit and implicit indications. Said means may include other aspects for providing QoS functionality contemporaneously with LIPA, such as the hardware and software components illustrated in FIGS. 5-9 for providing QoS functionality coupled to LIPA. The apparatus 1400 may include similar electrical components for performing any or all of the additional operations 1100, 1200 or 1300 described in connection with FIGS. 11-13, which for illustrative simplicity are not shown in FIG. 14.

In related aspects, the apparatus 1400 may optionally include a processor component 1410 having at least one processor, in the case of the apparatus 1400 configured as a network component and optionally incorporated into an access point. The processor 1410 may be in operative communication with the components 1402-1404 or similar components via a bus 1412 or similar communication coupling. The processor 1410 may effect initiation and scheduling of the processes or functions performed by electrical components 1402-1404. The processor 1410 may encompass the components 1402-1404, in whole or in part. In the alternative, the processor 1410 may be separate from the components 1402-1404, which may include one or more separate processors.

In further related aspects, the apparatus 1400 may include a network interface component 1414, which may in turn include two or more ports respectively dedicated for modem (WAN) access and LIPA. The apparatus may also include a radio transceiver component (not shown). A stand alone receiver and/or stand alone transmitter may be used in lieu of or in conjunction with the transceiver. In the alternative, or in addition, the apparatus 1400 may include multiple transceivers or transmitter/receiver pairs, which may be used to transmit and receive on different carriers. The apparatus 1400 may also include, or be coupled to, a backhaul interface (not shown) for communicating with other femtocells in the network and with any network entity connected to via the backhaul.

The apparatus 1400 may include a component for storing information, such as, for example, a memory device/component 1416. The computer readable medium or the memory component 1416 may be operatively coupled to the other components of the apparatus 1400 via the bus 1412 or the like. The memory component 1416 may be adapted to store computer readable instructions and data for performing the activity of the components 1402-1404, and subcomponents thereof, or the processor 1410, or the additional aspects 1100, 1200 or 1300, or the methods disclosed herein. The memory component 1416 may retain instructions for executing functions associated with the components 1402-1404. While shown as being external to the memory 1416, it is to be understood that the components 1402-1404 can exist within the memory 1416.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any non-transitory tangible medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the novel aspects described herein may be applied to other variations without departing from the spirit or scope of the disclosure. Thus, the disclosure is not intended to be limited to the examples and designs described above, and should be accorded the widest scope consistent with the principles and novel features disclosed herein.

What is claimed is:

1. A method for managing network traffic using a communications component, the method comprising:
providing local IP access (LIPA) for an access terminal using one or more local area network (LAN) addresses, using a QoS splitter component; and
providing, using the QoS splitter component, quality of service (QoS) functionality to the access terminal for data communicated via a modem, contemporaneously with providing the LIPA.

2. The method of claim 1, further comprising:
receiving data of a first traffic type from the access terminal;
receiving data of a second traffic type from the access terminal, wherein the second traffic type has a defined QoS requirement; and
assigning a higher priority to data of the second traffic type.

3. The method of claim 2, further comprising assigning the second traffic type to the data using an operation selected from dynamic assignment or static assignment.

4. The method of claim 2, further comprising receiving the data of the second traffic type from one or more port types.

5. The method of claim 1, further comprising using the LIPA to allow the access terminal to discover at least one client device connected to the QoS splitter component via a LAN.

6. The method of claim 1, wherein providing the QoS functionality comprises prioritizing data according to at least one of a defined latency requirement, a defined signal quality requirement, or a defined signal strength requirement.

7. The method of claim 1, wherein providing the one or more devices LIPA using one or more LAN addresses comprises assigning each of one or more LAN-connected devices an IPv4 address and implementing a dynamic host configuration protocol (DHCP) relay on an associated router.

8. The method of claim 1, wherein providing the one or more devices LIPA using one or more LAN addresses comprises assigning each of one or more LAN-connected devices an IP address within a local area network (LAN) subnet range.

9. The method of claim 1, wherein providing the one or more devices LIPA using one or more LAN addresses comprises performing a proxy address resolution protocol (ARP) function for each of one or more LAN-connected devices.

10. The method of claim 1, wherein providing the one or more devices LIPA using one or more LAN addresses comprises obtaining an IPv4 address and performing network address translation (NAT) between the IPv4 address and each of one or more LAN-connected devices.

11. The method of claim 1, wherein providing the one or more devices LIPA using one or more LAN addresses comprises implementing a neighbor discovery proxy function to allow each of one or more LAN-connected devices to obtain an IPv6 address.

12. An apparatus for managing network traffic, the apparatus comprising:
means for providing local IP access (LIPA) for an access terminal using one or more local area network (LAN) addresses; and
means for providing quality of service (QoS) functionality to the access terminal for data communicated via a modem, contemporaneously with providing the LIPA.

13. An apparatus for managing network traffic, comprising:
at least one processor configured for providing local IP access (LIPA) for an access terminal using one or more local area network (LAN) addresses, and providing quality of service (QoS) functionality to the access terminal for data communicated via a modem, contemporaneously with providing the LIPA; and
a memory coupled to the at least one processor for storing data.

14. The apparatus of claim 13, wherein the processor is further configured for
receiving data of a first traffic type from the access terminal;
receiving data of a second traffic type from the access terminal, wherein the second traffic type has a defined QoS requirement; and
assigning a higher priority to data of the second traffic type.

15. The apparatus of claim 14, wherein the processor is further configured for assigning the second traffic type to the data using an operation selected from dynamic assignment or static assignment.

16. The apparatus of claim 14, wherein the processor is further configured for receiving the data of the second traffic type from one or more port types.

17. The apparatus of claim 13, wherein the processor is further configured for using the LIPA to allow the access terminal to discover at least one client device connected to the QoS splitter component via a LAN.

18. The apparatus of claim 13, wherein the processor is further configured for providing the QoS functionality by prioritizing data according to at least one of a defined latency requirement, a defined signal quality requirement, or a defined signal strength requirement.

19. The apparatus of claim 13, wherein the processor is further configured for providing the one or more devices LIPA using one or more LAN addresses by assigning each of one or more LAN-connected devices an IPv4 address and implementing a dynamic host configuration protocol (DHCP) relay on an associated router.

20. The apparatus of claim 13, wherein the processor is further configured for providing the one or more devices LIPA using one or more LAN addresses by assigning each of one or more LAN-connected devices an IP address within a local area network (LAN) subnet range.

21. The apparatus of claim 13, wherein the processor is further configured for providing the one or more devices LIPA using one or more LAN addresses by performing a proxy address resolution protocol (ARP) function for each of one or more LAN-connected devices.

22. The apparatus of claim 13, wherein the processor is further configured for providing the one or more devices LIPA using one or more LAN addresses by obtaining an IPv4 address and performing network address translation (NAT) between the IPv4 address and each of one or more LAN-connected devices.

23. The apparatus of claim 13, wherein the processor is further configured for providing the one or more devices LIPA using one or more LAN addresses by implementing a neighbor discovery proxy function to allow each of one or more LAN-connected devices to obtain an IPv6 address.

24. A computer program product for managing network traffic, comprising:
a non-transitory computer-readable medium comprising code for providing local IP access (LIPA) for an access terminal using one or more local area network (LAN) addresses, and providing quality of service (QoS) functionality to the access terminal for data communicated via a modem, contemporaneously with providing the LIPA.

25. The computer program product according to claim 24, further comprising code for receiving data of a first traffic type from the access terminal;
receiving data of a second traffic type from the access terminal, wherein the second traffic type has a defined QoS requirement; and
assigning a higher priority to data of the second traffic type.

26. The computer program product according to claim 25, further comprising code for assigning the second traffic type to the data using an operation selected from dynamic assignment or static assignment.

27. The computer program product according to claim 25, further comprising code for receiving the data of the second traffic type from one or more port types.

28. The computer program product according to claim 24, further comprising code for using the LIPA to allow the access terminal to discover at least one client device connected to the QoS splitter component via a LAN.

29. The computer program product according to claim 24, further comprising code for providing the QoS functionality by prioritizing data according to at least one of a defined latency requirement, a defined signal quality requirement, or a defined signal strength requirement.

30. The computer program product according to claim 24, further comprising code for providing the one or more devices LIPA using one or more LAN addresses by assigning each of one or more LAN-connected devices an IPv4 address and implementing a dynamic host configuration protocol (DHCP) relay on an associated router.

31. The computer program product according to claim 24, further comprising code for providing the one or more devices LIPA using one or more LAN addresses by assigning each of one or more LAN-connected devices an IP address within a local area network (LAN) subnet range.

32. The computer program product according to claim 24, further comprising code for providing the one or more devices LIPA using one or more LAN addresses by performing a proxy address resolution protocol (ARP) function for each of one or more LAN-connected devices.

33. The computer program product according to claim 24, further comprising code for providing the one or more devices LIPA using one or more LAN addresses by obtaining an IPv4 address and performing network address translation (NAT) between the IPv4 address and each of one or more LAN-connected devices.

34. The computer program product according to claim 24, further comprising code for providing the one or more devices LIPA using one or more LAN addresses by implementing a neighbor discovery proxy function to allow each of one or more LAN-connected devices to obtain an IPv6 address.
